(19) United States
(12) Patent Application Publication
(10) Pub. No.: US 2024/0384419 A1
(43) Pub. Date: Nov. 21, 2024

(54) IN-SITU ELECTROLYTIC GAS COMPRESSION AND POWER OUTPUT SYSTEM USING STATIC PRESSURE OF SEAWATER

(71) Applicant: Ocean University of China, Qingdao City (CN)

(72) Inventors: Huajun Li, Qingdao City (CN); Kaisheng Zhang, Qingdao City (CN); Chenglong Luo, Qingdao City (CN); Wantao Jiang, Qingdao City (CN); Jing Li, Qingdao City (CN); Yujing Chen, Qingdao City (CN); Jiarui Xue, Qingdao City (CN); Baocheng Zhang, Qingdao City (CN); Qiang Wang, Qingdao City (CN)

(21) Appl. No.: 18/497,322

(22) Filed: Oct. 30, 2023

(30) Foreign Application Priority Data
May 18, 2023 (CN) 202310563526.X

(51) Int. Cl. C25B 1/04; C25B 9/70; C25B 15/02

(52) U.S. Cl. CPC C25B 1/04; C25B 9/70; C25B 15/02

(57) ABSTRACT

An in-situ electrolytic gas compression and power output system using static pressure of seawater; a deep-sea water electrolysis hydrogen production system includes multiple electrolytic tanks located in deep sea, an electrolytic power supply, an oxygen pressure stabilizing tank communicated with the electrolytic tanks through an oxygen transportation pipeline, and a hydrogen pressure stabilizing tank communicated with the electrolytic tanks through a hydrogen transportation pipeline; the oxygen pressure stabilizing tank is communicated with an oxygen pneumatic motor through a pipeline with a one-way valve; the hydrogen pressure stabilizing tank is communicated with a hydrogen pneumatic motor through a pipeline with a one-way valve to provide power output; hydrogen that has undergone work in the hydrogen pneumatic motor is transported to a sea surface hydrogen and oxygen collection relay ship through a hydrogen outlet pipeline for collection.

### CROSS-REFERENCE TO RELATED APPLICATION

This patent application claims the benefit and priority of Chinese Patent Application No. 202310563526.X filed with the China National Intellectual Property Administration on May 18, 2023, the disclosure of which is incorporated by reference herein in its entirety as part of the present application.

### TECHNICAL FIELD

The present disclosure relates to the technical field of hydrogen production, and in particular, to an in-situ electrolytic gas compression and power output system using static pressure of seawater.

### BACKGROUND

In offshore wind power and photovoltaic hydrogen production, electric energy generated by offshore wind power generation and photovoltaic power generation is used to electrolyze water on the sea surface to produce hydrogen.

In onshore water electrolysis hydrogen production, electric energy from a power grid is used to electrolyze water on land to produce hydrogen.

A water electrolysis hydrogen production system includes two major parts: a hydrogen production system and a purification system. In the hydrogen production system, alkali liquor is circulated in an electrolytic tank through an alkali liquor circulation pump. Through electrochemical reactions, hydrogen is produced at a cathode, and oxygen is produced at an anode. Then, the alkali liquor flows out of the electrolytic tank together with hydrogen or oxygen (hydrogen and oxygen are discharged through separate discharge pipelines, and then enter corresponding post-treatment systems, which are referred to as a hydrogen side and an oxygen side), and enters a heat exchanger on the hydrogen side or the oxygen side. Afterwards, the alkali liquor with hydrogen or oxygen enters a gas-liquid separator on the hydrogen side or the oxygen side, where the alkali liquor is separated from hydrogen or oxygen. The alkali liquor enters the electrolysis tank again through the alkali liquor circulation pump, and hydrogen or oxygen enters a scrubber on the hydrogen side or the oxygen side to remove alkali mist entrained in hydrogen or oxygen. Then, hydrogen is evacuated or enters a purification system, and oxygen is evacuated or collected as a byproduct. In the purification system, hydrogen from the hydrogen production system reacts with a Pd catalyst at a temperature above 200 degrees Celsius to remove a small amount of oxygen from hydrogen, and then generated water is separated from hydrogen through the heat exchanger and the gas-water separator. Afterwards, hydrogen enters an absorption tower to absorb the moisture in hydrogen, obtaining hydrogen with a purity of over 99.99% for subsequent storage or use.

At present, the core requirements of the industry for a hydrogen storage technology are safety, high capacity, and low cost. High-pressure gaseous hydrogen storage is easy to operate, low in cost, and mature in technology, but there are certain potential safety hazards due to high pressure, and a low hydrogen storage density leads to low hydrogen storage efficiency. Low-temperature liquid hydrogen storage has advantages in hydrogen storage density, with a volume density more than twice that of the high-pressure gaseous hydrogen storage at 80 MPa. However, the low-temperature liquid hydrogen storage has high refrigeration energy consumption and extremely high storage cost. In a unit storage and transportation cost calculation model for hydrogen, a unit hydrogen compression cost for a hydrogen production unit is calculated as 0.85 yuan/kg, and a unit hydrogen compression cost for a hydrogen use unit is calculated as 0.43 yuan/kg.

The existing water electrolysis hydrogen production equipment is generally installed on land or near offshore wind power and photovoltaic facilities, and there is a gap in deep-sea water electrolysis hydrogen production equipment. Therefore, the present disclosure provides a system for producing hydrogen by water electrolysis in deep sea and utilizing static pressure in the deep sea. By designing a deep-sea water electrolysis equipment and designing a high-pressure-gas pneumatic motor for power generation, the gap in deep-sea water electrolysis hydrogen production equipment is filled in, and the static pressure in the deep sea is utilized to achieve dual-purposes of hydrogen and oxygen compression and power output.

### SUMMARY

The present disclosure aims to provide an in-situ electrolytic gas compression and power output system using static pressure of seawater. First, the static pressure in the deep sea is utilized to achieve pressurization of hydrogen and oxygen produced by electrolysis, and the problem of pressurization energy consumption in the current hydrogen production process is solved. Second, energy utilization is achieved by pneumatic motors during a transportation process of high-pressure hydrogen and oxygen, thereby power output is achieved.

In order to solve the above technical problems, the present disclosure adopts the following technical solution:
The present disclosure provides an in-situ electrolytic gas compression and power output system using static pressure of seawater, including a deep-sea water electrolysis hydrogen production system,
wherein the deep-sea water electrolysis hydrogen production system includes multiple electrolytic tanks located in deep sea, an electrolytic power supply, an oxygen pressure stabilizing tank communicated with the electrolytic tanks through an oxygen transportation pipeline, and a hydrogen pressure stabilizing tank communicated with the electrolytic tanks through a hydrogen transportation pipeline,
the oxygen pressure stabilizing tank is communicated with an oxygen pneumatic motor through a pipeline with a one-way valve; and oxygen that has undergone work in the oxygen pneumatic motor is transported to a sea surface hydrogen and oxygen collection relay ship through an oxygen outlet pipeline,
the hydrogen pressure stabilizing tank is communicated with a hydrogen pneumatic motor through a pipeline with a one-way valve; and hydrogen that has undergone work in the hydrogen pneumatic motor is transported to a sea surface hydrogen and oxygen collection relay ship through a hydrogen outlet pipeline for collection.

Further, the electrolytic power supply is one or more of a power supply from offshore photovoltaic power generation, a power supply from offshore wind power generation, and a power supply from onshore power generation; and/or,

the electrolytic power supply is from one of offshore nuclear power, thermal power, biomass power generation, and garbage power generation.

Further, oxygen pressurization devices are arranged between the oxygen pressure stabilizing tank and the electrolytic tanks; hydrogen pressurization devices are arranged between the hydrogen pressure stabilizing tank and the electrolytic tanks; and one-way valves are arranged on the oxygen transportation pipeline and the hydrogen transportation pipeline, respectively.

The structure of the oxygen pressurization devices is the same as the structure of the hydrogen pressurization devices; and/or,
the oxygen pressurization devices, through a work of water pressure, compress oxygen produced in the electrolytic tanks, and the pressurized oxygen is transported to the oxygen pressure stabilizing tank; and/or,
the oxygen pressurization devices are of an air bag structure or a piston compression structure communicated to the outside.

Compared with the prior art, the present disclosure has the following beneficial technical effects.
1) The static pressure of seawater in the deep sea is used to pressurize hydrogen and oxygen produced by electrolysis, which saves the pressurization costs in the existing hydrogen production process.
2) During the transportation process of high-pressure hydrogen and oxygen, the utilization of the static pressure in the deep sea is achieved through the pneumatic motors, thereby power output is achieved.

### BRIEF DESCRIPTION OF THE DRAWINGS

The present disclosure is further described below in combination with drawing illustrations.

FIG. 1 is a schematic structural diagram of an in-situ electrolytic gas compression and power output system using static pressure of seawater according to the present disclosure;

FIG. 2 is a top-view installation schematic diagram of an in-situ electrolytic gas compression and power output system using static pressure of seawater according to the present disclosure; and

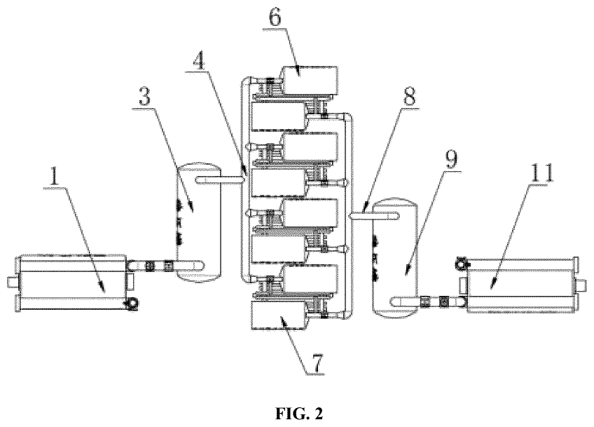

FIG. 3 is a schematic diagram of a working process of an in-situ electrolytic gas compression and power output system using static pressure of seawater according to the present disclosure.

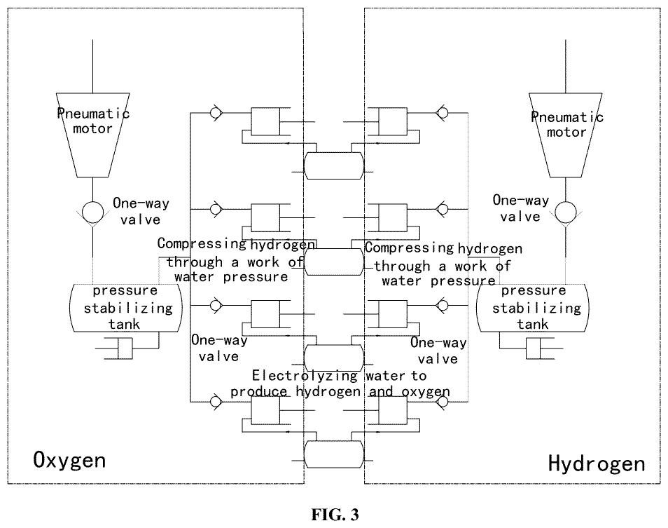

Description of reference numerals: 1 oxygen pneumatic motor; 2 oxygen outlet pipeline; 3 oxygen pressure stabilizing tank; 4 oxygen transportation pipeline; 5 electrolytic tank; 6 oxygen pressurization device; 7 hydrogen pressurization device; 8 hydrogen transportation pipeline; 9 hydrogen pressure stabilizing tank; 10 hydrogen outlet pipeline; and 11 hydrogen pneumatic motor.

### DETAILED DESCRIPTION OF THE EMBODIMENTS

This embodiment discloses an in-situ electrolytic gas compression and power output system using static pressure of seawater, including a deep-sea water electrolysis hydrogen production system.

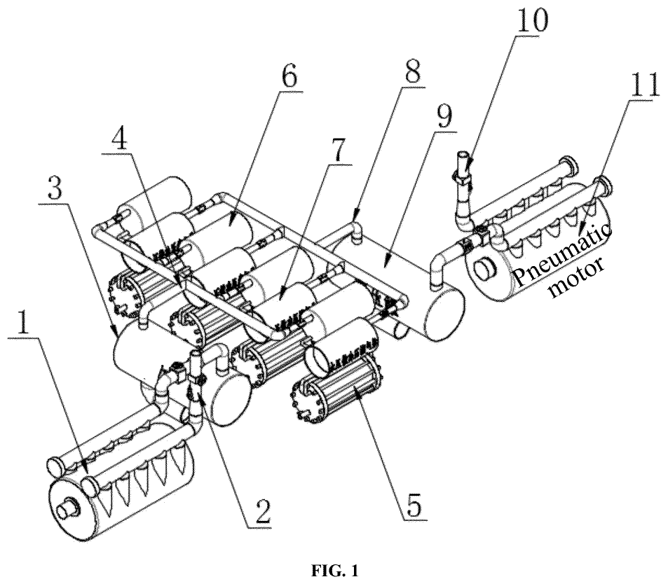

As shown in FIG. 1, the deep-sea water electrolysis hydrogen production system includes multiple electrolytic tanks 5 located in deep sea, an electrolytic power supply, an oxygen pressure stabilizing tank 3 communicated with the electrolytic tanks 5 through an oxygen transportation pipeline 4, and a hydrogen pressure stabilizing tank 9 communicated with the electrolytic tanks 5 through a hydrogen transportation pipeline 8.

The oxygen pressure stabilizing tank 3 is communicated with an oxygen pneumatic motor 1 through a pipeline with a one-way valve; and oxygen that has undergone work in the oxygen pneumatic motor 1 is transported to a sea surface hydrogen and oxygen collection relay ship through an oxygen outlet pipeline 2.

The hydrogen pressure stabilizing tank 9 is communicated with a hydrogen pneumatic motor 11 through a pipeline with a one-way valve; and hydrogen that has undergone work in the hydrogen pneumatic motor 11 is transported to a sea surface hydrogen and oxygen collection relay ship through a hydrogen outlet pipeline 10 for collection.

Thus, in the present disclosure, transportation is achieved between the sea surface hydrogen and oxygen collection relay ship and the deep-sea water electrolysis hydrogen production system through the oxygen outlet pipeline and the hydrogen outlet pipeline.

The working principle thereof is as follows.

Oxygen that has entered the oxygen pressure stabilizing tank 3 enters the oxygen pneumatic motor 1 through the pipeline with the one-way valve, meanwhile, oxygen that has undergone work in the oxygen pneumatic motor 1 is transported to the sea surface hydrogen and oxygen collection relay ship through the oxygen outlet pipeline 2. Due to a pressure difference between oxygen in the oxygen pressure stabilizing tank 3 and oxygen in the sea surface hydrogen and oxygen collection relay ship, oxygen may be transported continuously without an action of an external force. During the transportation process, when oxygen passes through the oxygen pneumatic motor 1, most of the pressure difference is converted into a rotational power of the oxygen pneumatic motor 1.

The working principle of the hydrogen pressure stabilizing tank 9 and the working principle of the oxygen pressure stabilizing tank 3 are the same, and the working principle of the hydrogen pneumatic motor 11 and the working principle of the oxygen pneumatic motor 1 are the same, and thus the working principle of the hydrogen pressure stabilizing tank 9 and the working principle of the hydrogen pneumatic motor 11 will not be repeatedly described.

In this embodiment, the effects of energy saving and environmental protection are achieved.

The electrolytic power supply is one or more of a power supply from offshore photovoltaic power generation, a power supply from offshore wind power generation, and a power supply from onshore power generation. The electrolytic power supply is from one of offshore nuclear power, thermal power, biomass power generation, and garbage power generation.

Particularly, a power supply from offshore wind power generation is preferred, since electric power generated by offshore wind power generation is not stable enough, and it can easily cause a burden of power transmission if the electric power is directly incorporated into a power grid. Based on this, part of the power supply is directly applied to electrolytic hydrogen production, thereby it is convenient to use local materials and save the investment costs of power transmission and distribution facilitates.

In this embodiment, oxygen pressurization devices 6 are arranged between the oxygen pressure stabilizing tank 3 and the electrolytic tanks 5; hydrogen pressurization devices 7 are arranged between the hydrogen pressure stabilizing tank 9 and the electrolytic tanks 5; and one-way valves are arranged on the oxygen transportation pipeline 4 and the hydrogen transportation pipeline 8, respectively.

The structure of the oxygen pressurization devices 6 is the same as the structure of the hydrogen pressurization devices 7. The oxygen pressurization devices 6 are of an air bag structure or a piston compression structure communicated to the outside.

The pressure of oxygen in the oxygen pressurization devices 6 or the pressure of hydrogen in the hydrogen pressurization devices 7 is the same as the pressure of external seawater, so that oxygen or hydrogen is pressurized by the pressure of seawater.

Particularly, the oxygen pressurization devices 6, through a work of water pressure, compress oxygen produced in the electrolytic tanks, and the pressurized oxygen is transported to the oxygen pressure stabilizing tank.

Particularly, the principle of oxygen pressurization is as follows.

Oxygen produced in the electrolytic tanks 5 is transported to the oxygen pressurization devices 6 through the oxygen transportation pipeline 4, and the oxygen pressurization devices 6 transport oxygen with the same pressure as the pressure of external seawater to the oxygen pressure stabilizing tank through the oxygen transportation pipeline 4 with the one-way valve.

Electrolyte water input into the electrolytic tanks 5 is taken in situ through a pump, so that the water pressure in the electrolytic tanks 5 is slightly greater than the external water pressure, and the pressure of oxygen produced by electrolysis or the pressure of hydrogen produced by electrolysis is slightly greater than the external pressure.

Particularly, oxygen produced in the electrolytic tanks 5 overcomes the pressure of seawater on the oxygen pressurization devices 6 (an air bag or a piston structure communicated to the outside), so that the pressure of the oxygen transported to the oxygen pressure stabilizing tank is the same as the pressure of the seawater at a depth where the oxygen pressure stabilizing tank is located.

The working principle thereof is as follows. First, the seawater is pumped into the electrolytic tanks after pretreated, and a water level is controlled through an electronic system. An external power supply is coupled to the electrolytic tanks. The seawater is electrolyzed in the electrolytic tanks to produce hydrogen and oxygen at two electrodes. After produced by ionization, oxygen and hydrogen are respectively fed into corresponding pressurization devices, and then oxygen and hydrogen are compressed by the pressure of seawater through the corresponding pressurization devices, so that the pressure of oxygen or the pressure of hydrogen is equal to the pressure of seawater. The pressurized high-pressure oxygen or hydrogen is fed into a high-pressure oxygen or hydrogen pressure stabilizing tank for storage. After output from the pressure stabilizing tank, oxygen or hydrogen is fed into a pneumatic motor through a transportation pipeline, and the pneumatic motor is driven to rotate to output power. An outlet pipeline of the pneumatic motor is communicated with a pipe led to the sea surface. The depressurized oxygen or hydrogen is transported to the sea surface and kept at a certain pressure, which can be directly output for use or canned for transportation.

The above embodiments only describe the preferred modes of the present disclosure, and do not limit the scope of the present disclosure. Various variations and improvements that are made by those of ordinary skill in the art to the technical solutions of the present disclosure without departing from the design spirit of the present disclosure shall all fall within the protection scope defined by the claims of the present disclosure.

1. An in-situ electrolytic gas compression and power output system using static pressure of seawater, comprising a deep-sea water electrolysis hydrogen production system,
wherein the deep-sea water electrolysis hydrogen production system comprises a plurality of electrolytic tanks located in deep sea, an electrolytic power supply, an oxygen pressure stabilizing tank communicated with the electrolytic tanks through an oxygen transportation pipeline, and a hydrogen pressure stabilizing tank communicated with the electrolytic tanks through a hydrogen transportation pipeline,
wherein the oxygen pressure stabilizing tank is communicated with an oxygen pneumatic motor through a pipeline with a one-way valve; and oxygen that has undergone work in the oxygen pneumatic motor is transported to a sea surface hydrogen and oxygen collection relay ship through an oxygen outlet pipeline;
the hydrogen pressure stabilizing tank is communicated with a hydrogen pneumatic motor through a pipeline with a one-way valve; and hydrogen that has undergone work in the hydrogen pneumatic motor is transported to a sea surface hydrogen and oxygen collection relay ship through a hydrogen outlet pipeline for collection.

2. The in-situ electrolytic gas compression and power output system using static pressure of seawater according to claim 1, wherein the electrolytic power supply is one or more of a power supply from offshore photovoltaic power generation, a power supply from offshore wind power generation, and a power supply from onshore power generation; and/or,
the electrolytic power supply is from one of offshore nuclear power, thermal power, biomass power generation, and garbage power generation.

3. The in-situ electrolytic gas compression and power output system using static pressure of seawater according to claim 1, wherein oxygen pressurization devices are arranged between the oxygen pressure stabilizing tank and the electrolytic tanks; hydrogen pressurization devices are arranged between the hydrogen pressure stabilizing tank and the electrolytic tanks; and one-way valves are arranged on the oxygen transportation pipeline and the hydrogen transportation pipeline, respectively;
the structure of the oxygen pressurization devices is the same as the structure of the hydrogen pressurization devices; and/or,
the oxygen pressurization devices, through a work of water pressure, compress oxygen produced in the electrolytic tanks, and the pressurized oxygen is transported to the oxygen pressure stabilizing tank; and/or,
the oxygen pressurization devices are of an air bag structure or a piston compression structure communicated to the outside.
